(19) United States
(12) Patent Application Publication
(10) Pub. No.: US 2018/0136499 A1
(43) Pub. Date: May 17, 2018

(54) CURABLE COMPOSITIONS FOR ONE DROP FILL SEALANT APPLICATION

(71) Applicants: Henkel IP & Holding GmbH, Duesseldorf (DE); Henkel AG & Co. KGaA, Duesseldorf (DE)

(72) Inventors: Laxmisha M. Sridhar, Monmouth Junction, NJ (US); Baoshan Gao, Shanghai (CN); Jing Zhou, Shanghai (CN)

(21) Appl. No.: 15/871,056

(22) Filed: Jan. 14, 2018

Related U.S. Application Data
(63) Continuation of application No. PCT/CN2015/083966, filed on Jul. 14, 2015.

(51) Int. Cl. G02F 1/1339; C08G 65/38; C08G 59/02

(52) U.S. Cl. CPC G02F 1/1339; G02F 2001/13398; C08G 59/02; C08G 65/38

(57) ABSTRACT

The present invention relates to bismaleimide resins and curable compositions for One Drop Fill sealant applications using such resins, particularly in liquid crystal display assembly applications. The inventive compositions can be cured by a UV, thermal or a combination of UV and thermal.

### BACKGROUND

### Field

The present invention relates to monomers and oligomers useful as sealants and particularly as one drop fill sealants for liquid crystal applications. In particular, the present invention permits assembly of LCD panels without migration of the sealant resin into the liquid crystal or vice versa during LCD assembly and/or curing of the resin.

### Brief Description of Related Technology

The one drop fill (“ODF”) process is becoming the mainstream process in the assembly of LCD panels in display applications, replacing the conventional vacuum injection technology to meet faster manufacturing process demands. In the ODF process, first, a sealant is dispensed on an electrode-equipped substrate to form a frame of a display element, and liquid crystals are dropped inside the depicted frame. In the next step of the assembly, another electrode equipped substrate is joined thereto under vacuum. Then, the sealant undergoes a curing process, either by a combination of UV and thermal or by thermal only process.

The ODF method has a few problems in that the sealant material in the uncured state comes into contact with the liquid crystal during the assembly process. This could cause reduction in electro-optical properties of the liquid crystal by resin migration into the liquid crystal or vice versa, or because of ionic impurities that may be present. Hence, design of resin systems for sealant material that show good liquid crystal resistance (less contamination) along with good adhesion and moisture barrier properties has remained a challenge.

### SUMMARY

The present invention relates to unique resins and ODF compositions made therefrom.

In one aspect of the invention there is provided a resin comprising the structure I:

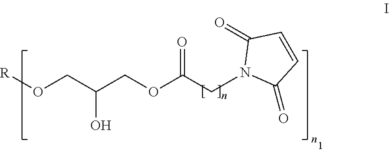

### Wherein

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
n and n₁ are each independently 1-10.

In another aspect of the invention there is included a resin having the structure II:

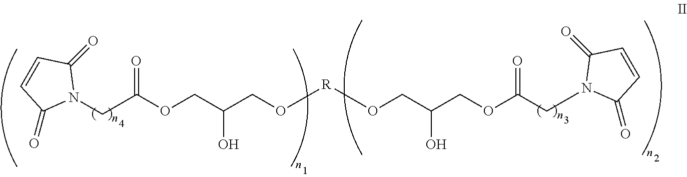

### Wherein

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and n₁, n₂, n₃, and n₄ are each independently 1-10.

In yet another aspect of the invention there is included a resin having the structure III:

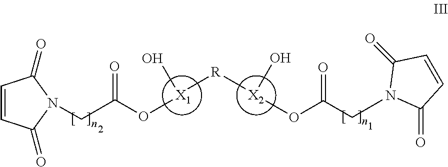

### Wherein

X₁ and X₂ are 3-10 membered rings independently selected from functionalized or unfunctionalized alicycyclic groups optionally having one or more heteroatoms;
n₁ and n₂ are each independently 1-10;
wherein R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, ticycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
R is linked to the ring structures X₁ and X₂ at any position with a proviso that the hydroxyl groups on X₁ and X₂ rings are adjacent to the maleimidoalkanoyl groups.

In still another aspect of the invention there is included a resin having the structure IV:

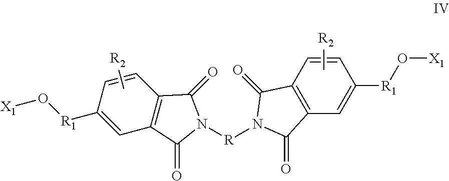

### Wherein

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ can be a carbonyl group; an aliphatic or aromatic linker and may contain one or more of ester, ether, hydroxyl or thioether groups;
R₂ is a substituent on the aromatic ring, which can be H, halogen, alkyl, alkyl ether, thioether group; and
X₁ is selected from maleimidoalkanoyl or maleimidoaroyl group.

In another aspect of the invention there is included a resin having the structure V:

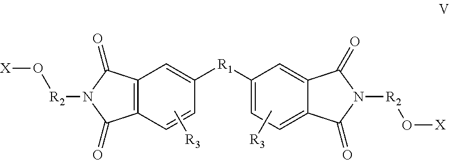

### Wherein

R₁ can be just a bond linking the two aromatic groups; O; carbonyl; or a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
R₂ is an aliphatic or aromatic linker group which may contain one or more of ester, ether, hydroxyl, thioether or carbonate groups;
R₃ is a substituent on the aryl group, which may be H, halogen, alkyl, alkyl ether, or thio ether group; and
X is a polymerizable functionality selected from maleimidoalkanoyl and maleimidoaroyl groups.

In another aspect of the invention there is included a resin having the structure VI:

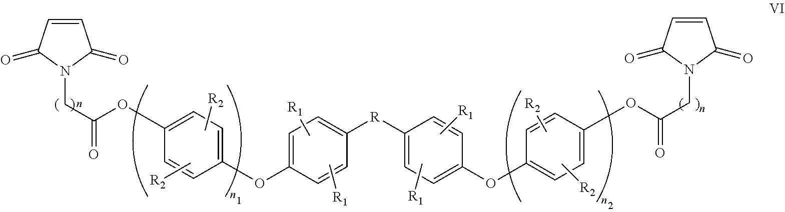

### Wherein

R is a divalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ and R₂ are linear or branched aliphatic groups optionally containing heteroatoms;
n is 1-10, and n₁ and n₂ are each 1-100.

### DETAILED DESCRIPTION

The polymers of the present invention are useful in a wide variety of applications including sealing, adhesion and coating. One particularly desirable use is as an ODF sealant for assembling LCD panels.

The present invention includes a number of novel materials including resins, oligomers and polymers useful for preparing curable compositions which may be used for ODF sealants. The present invention also includes novel compositions made from the disclosed resins. For purposes of this invention, the term “resins” will include the aforementioned the novel materials, i.e. resins, oligomers and polymers.

One aspect of the invention includes a curing resin composition for use as an ODF sealant, which includes resins represented by the general structural formulae shown above.

The glycidyl ether/ester compounds useful in synthesizing the inventive hybrid resins described herein is not particularly limited, and examples of the epoxy compounds available in the market include: bisphenol A type epoxy resins such as Epikote 828EL and Epikote 1004 (all manufactured by Japan Epoxy Resin Co., Ltd.); bisphenol F type epoxy resins such as Epikote 806 and Epikote 4004 (all manufactured by Japan Epoxy Resin Co., Ltd.); bisphenol S type epoxy resins such as Epiclon EXA1514 (manufactured by Dainippon Ink and Chemicals Inc.) and SE 650 manufactured by Shin A T&C; 2,2′-diallyl bisphenol A type epoxy resins such as RE-81 ONM (manufactured by Nippon Kayaku Co., Ltd.); hydrogenated bisphenol type epoxy resins such as Epiclon EXA7015 (manufactured by Dainippon Ink and Chemicals Inc.); propyleneoxide-added bisphenol A type epoxy resins such as EP-4000S (manufactured by ADEKA Corporation); resorcinol type epoxy resins such as EX-201 (manufactured by Nagase ChemteX Corporation); biphenyl type epoxy resins such as Epikote YX-4000H (manufactured by Japan Epoxy Resin Co., Ltd.); sulfide type epoxy resins such as YSLV 50TE (manufactured by Tohto Kasei Co., Ltd.); ether type epoxy resins such as YSLV 80DE (manufactured by Tohto Kasei Co., Ltd.); dicyclopentadiene type epoxy resins such as EP-4088S and EP4088L (manufactured by ADEKA Corporation); naphthalene type epoxy resins such as SE-80, SE-90, manufactured by Shin A T&C; glycidyl amine type epoxy resins such as Epikote 630 (manufactured by Japan Epoxy Resin Co., Ltd.), Epiclon 430 (manufactured by Dainippon Ink and Chemicals Inc.) and TETRAD-X (manufactured by Mitsubishi Gas Chemical Company Inc.); alkylpolyol type epoxy resins such as ZX-1542 (manufactured by Tohto Kasei Co., Ltd.), Epiclon 726 (manufactured by Dainippon Ink and Chemicals Inc.), Epolight 8OMFA (manufactured by Kyoeisha Chemical Co., Ltd.) and Denacol EX-611 (manufactured by Nagase ChemteX Corporation); rubber modified type epoxy resins such as YR-450, YR-207 (all manufactured by Tohto Kasei Co., Ltd.) and Epolead PB (manufactured by Daicel Chemical Industries, Ltd.); glycidyl ester compounds such as Denacol

EX-147 (manufactured by Nagase ChemteX Corporation); bisphenol A type episulfide resins such as Epikote YL-7000 (manufactured by Japan Epoxy Resin Co., Ltd.); and others such as YDC-1312, YSLV-BOXY, YSLV-90CR (all manufactured by Tohto Kasei Co., Ltd.), XAC4151 (manufactured by Asahi Kasei Corporation), Epikote 1031, Epikote 1032 (all manufactured by Japan Epoxy Resin Co., Ltd.), EXA-7120 (manufactured by Dainippon Ink and Chemicals Inc.), TEPIC (manufactured by Nissan Chemical Industries, Ltd.). Examples of the commercially available phenol novolak type epoxy compound include Epiclon N-740, N-770, N-775 (all manufactured by Dainippon Ink and Chemicals Inc.), Epikote 152, Epikote 154 (all manufactured by Japan Epoxy Resin Co., Ltd.), and the like. Examples of the commercially available cresol novolak type epoxy compound include Epiclon N-660, N-665, N-670, N-673, N-680, N-695, N-665-EXP and N-672-EXP (all manufactured by Dainippon Ink and Chemicals Inc.); an example of the commercially available biphenyl novolak type epoxy compound is NC-3000P (manufactured by Nippon Kayaku Co., Ltd.); examples of the commercially available trisphenol novolak type epoxy compound include EP1032S50 and EP1032H60 (all manufactured by Japan Epoxy Resin Co., Ltd.); examples of the commercially available dicyclopentadiene novolak type epoxy compound include XD-1000-L (manufactured by Nippon Kayaku Co., Ltd.) and HP-7200 (manufactured by Dainippon Ink and Chemicals Inc.); examples of the commercially available bisphenol A type epoxy compound include Epikote 828, Epikote 834, Epikote 1001, Epikote 1004 (all manufactured by Japan Epoxy Resin Co., Ltd.), Epiclon 850, Epiclon 860 and Epiclon 4055 (all manufactured by Dainippon Ink and Chemicals Inc.); examples of the commercially available bisphenol F type epoxy compound include Epikote 807 (manufactured by Japan Epoxy Resin Co., Ltd.) and Epiclon 830 (manufactured by Dainippon Ink and Chemicals Inc.); an example of the commercially available 2,2′-diallyl bisphenol A type epoxy compound is RE-81ONM (manufactured by Nippon Kayaku Co., Ltd.); an example of the commercially available hydrogenated bisphenol type epoxy compound is ST-5080 (manufactured by Tohto Kasei Co., Ltd.); examples of the commercially available polyoxypropylene bisphenol A type epoxy compound include EP-4000 and EP-4005 (all manufactured by ADEKA Corporation); and the like. 11P4032 and Epiclon EXA-4700 (all manufactured by Dainippon Ink and Chemicals Inc.); phenol novolak type epoxy resins such as Epiclon N-770 (manufactured by Dainippon Ink and Chemicals Inc.); orthocresol novolak type epoxy resins such as Epiclon N-670-EXP-S (manufactured by Dainippon Ink and Chemicals Inc.); dicyclopentadiene novolak type epoxy resins such as Epiclon HP7200 (manufactured by Dainippon Ink and Chemicals Inc.); biphenyl novolak type epoxy resins such as NC-3000P (manufactured by Nippon Kayaku Co., Ltd.); naphthalene phenol novolak type epoxy resins such as ESN-165S (manufactured by Tohto Kasei Co., Ltd.).

Examples of the alicyclic epoxy compounds useful in synthesizing the inventive resins include, without limitation, polyglycidyl ethers of polyhydric alcohols having at least one alicyclic ring and cyclohexene oxide- or cyclopentene oxide containing compounds obtained by epoxidizing cyclohexene ring or cyclopentene ring-containing compounds. Specific examples include hydrogenated bisphenol A diglycidyl ether, 3,4-epoxycyclohexylmethyl 3,4-epoxycyclohexanecarboxylate, 3,4-epoxy-1-methyl cyclohexyl-3,4-epoxy-1-methylcyclohexanecarboxylate, 6-methyl-3,4-epoxycyclohexylmethyl-6-methyl-3,4-epoxycyclohexanecarboxylate, 3,4-epoxy-3-methylcyclohexylmethyl 3,4-epoxy-3-methylcyclohexanecarboxylate, 3,4-epoxy-5-methylcylcohexylmethyl-3,4-epoxy-5-methylcyclohexanecarboxylate, 2-(3,4-epoxycyclohexyl-5,5-spiro-3,4-epoxy)cyclohexane-metadioxane, bis(3,4-epoxycyclohexylmethyl)adipate, 3,4-epoxy-6-methylcyclohexyl carboxylate, methylenebis(3,4-epoxycyclohexane), dicyclopentadiene diepoxide, ethylenebis(3,4-epoxycyclohexanecarboxylate), dioctylepoxyhexahydrophthalate, and di-2-ethylhexyl epoxyhexahydrophthalate.

Some of the above-mentioned alicyclic epoxy resins are Commercially available in the following products: UVR-6100, UVR-6105, UVR-6110, UVR-6128, and UVR-6200 (products of Union Carbide Corporation); CELLOXIDE 2021, CELLOXIDE 2021P, CELLOXIDE 2081, CELLOXIDE 2083, CELLOXIDE 2085, CELLOXIDE 2000, CELLOXIDE 3000, CYCLMER A200, CYCLMER M100, CYCLMER M101, EPOLEAD GT-301, EPOLEAD GT-302, EPOLEAD 401, EPOLEAD 403, ETHB, and EPOLEADHD 300 (products of Daicel Chemical Industries, Ltd.); KRM-2110, and KRM-2199 (products of ADEKA Corporation).

In addition to the curable polymers of the present invention, ODF sealant compositions may also include a free radical initiator (thermal or UV generated) and a curing agent. Curing of the ODF compositions may be by thermal or UV mechanisms or both. In embodiments where an epoxide ring is present, a latent epoxy curing agent may also be employed.

Useful thermal free radical initiators include, for example, organic peroxides and azo compounds that are known in the art. Examples include: azo free radical initiators such as AIBN (azodiisobutyronitrile), 2,2′-Azobis(4-methoxy-2,4-dimethyl valeronitrile), 2,2′-Azobis(2,4-dimethyl valeronitrile), Dimethyl 2,2′-azobis(2-ethylpropionate), 2,2′-Azobis(2-methylbutyronitrile), 1,11-Azobis(cyclohexane-1-carbonitrile), 2,2′-Azobis[N-(2-propenyl)-2-methylpropionamide]; dialkyl peroxide free radical initiators such as 1,1-di-(butylperoxy-3,3,5-trimethyl cyclohexane); alkyl perester free radical initiators such as TBPEH (t-butyl per-2-ethylhexanoate); diacyl peroxide free radical initiators such as benzoyl peroxide; peroxy dicarbonate radical initiators such as ethyl hexyl percarbonate; ketone peroxide initiators such as methyl ethyl ketone peroxide, bis(t-butyl peroxide) diisopropylbenzene, t-butylperbenzoate, t-butyl peroxy neodecanoate, and combinations thereof.

Further examples of organic peroxide free radical initiators include: Dilauroyl peroxide, 2,2-Di(4,4-di(tert-butylperoxy)cyclohexyl)propane, Di(tert-butylperoxyisopropyl) benzene, Di(4-tert-butylcyclohexyl) peroxydicarbonate, Dicetyl peroxydicarbonate, Dimyristyl peroxydicarbonate, 2,3-Dimethyl-2,3-diphenylbutane, Dicumyl peroxide, Dibenzoyl peroxide, Diisopropyl peroxydicarbonate, tert-Butyl monoperoxymaleate, 2,5-Dimethyl-2,5-di(tert-butylperoxy)hexane, tert-Butylperoxy 2-ethylhexyl carbonate, tert-Amyl peroxy-2-ethylhexanoate, tert-Amyl peroxypivalate, tert-Amylperoxy 2-ethylhexyl carbonate, 2,5-Dimethyl-2,5-di(2-ethylhexanoylperoxy) hexane 2,5-Dimethyl-2,5-di(tert-butylperoxy) hexpe-3, Di(3-methoxybutyl)peroxydicarbonate, Diisobutyryl peroxide, tert-Butyl peroxy-2-ethylhexanoate (Trigonox 21 S), 1,1-Di(tert-butylperoxy)cyclohexane, tert-Butyl peroxyneodecanoate, tert-Butyl peroxypivalate, tert-Butyl peroxyneoheptanoate, tert-Butyl peroxydiethylacetate, 1,1-Di(tert-butylperoxy)-3,3,5-trimethylcyclohexane, 3,6,9-Triethyl-3,6,9-trimethyl-1,4,7-triperoxonane, Di(3,5,5-trimethylhexanoyl) peroxide, tert-Butyl peroxy-3,5,5-trimethyl hexanoate, 1,1,3,3-Tetramethylbutyl peroxy-2-ethylhexanoate, 1,1,3,3-tetramethylbutyl peroxyneodecanoate, tert-Butyl peroxy-3,5,5-trimethyl hexanoate, Cumyl peroxyneodecanoate, Di-tert-butyl peroxide, tert-Butylperoxy isopropyl carbonate, tert-Butyl peroxybenzoate, Di(2-ethylhexyl) peroxydicarbonate, tert-Butyl peroxyacetate, Isopropylcumyl hydroperoxide, and tert-Butyl cumyl peroxide.

Normally the thermal free radical initiator with higher decomposition rate is preferred, as this can generate free radicals more easily at common cure temperature (80-130° C.) and give faster cure speed, which can reduce the contact time between liquid resin and liquid crystal, and reduce the liquid crystal contamination. On the other hand, if the decomposition rate of initiator is too high, the viscosity stability at room temperature will be influenced, thereby reducing the work life of the sealant.

A convenient way of expressing the decomposition rate of an initiator at a specified temperature is in terms of its half-life i.e., the time required to decompose one-half of the peroxide originally present. To compare reactivity of different initiators, the temperature at which each initiator has a half-life (T½) of 10 hours is used. The most reactive (fastest) initiator would be the one with the lowest 10 h T½ temperature.

In the present invention, the thermal free radical initiator with 10 h T½ temperature of 30-80° C. is preferred, and with 10 h T½ temperature of 40-70° C. is more preferred.

To balance the reactivity and viscosity stability of the composition, the thermal free radical initiator used in the resin composition is in an amount of usually 0.01 to 3 parts by weight, and preferably 0.5 to 2 parts by weight, based on 100 parts by weight of the inventiveresin in the curable composition of the present invention.

Useful UV free radical initiators include Norrish type I cleavage photoinitiators that are commercially available from CIBA and BASF. These photoinitiators are used in the amount 0.1-5 wt %, more preferably in about 0.2 to 3 wt % in the formulation.

Examples of useful epoxy curing agent include but are not limited to the Ajicure series of hardeners available from Ajinomoto Fine-Techno Co., Inc.; the Amicure series of curing agents available from Air products and the JERCURE™ products available from Mitsubushi Chemical. These curing agents or hardeners or hardeners are used in the amount of about 1% to about 50% by weight of the total composition, more preferably from about 5% to about 20% by weight of the total composition.

The curable composition may optionally contain, as desired, a further component capable of a photopolymerization reaction such as a vinyl ether compound. In addition, the curable composition may further comprise additives, resin components and the like to improve or modify properties such as flowability, dispensing or printing property, storage property, curing property and physical property after curing. Various additives may be contained in the composition as desired, for example, organic or inorganic fillers, thixotropic agents, silane coupling agents, diluents, modifiers, coloring agents such as pigments and dyes, surfactants, preservatives, stabilizers, plasticizers, lubricants, defoamers, leveling agents and the like; however it is not limited to these. In particular, the composition preferably comprises an additive selected from the group consisting of organic or inorganic filler, a thixotropic agent, and a silane coupling agent. These additives may be present in amounts of about 0.1% to about 50%, more preferably from about 2% to about 10% by weight of the total composition.

The filler may include, but is not limited to, inorganic fillers such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; meanwhile, organic fillers such as poly(methyl) methacrylate, poly(ethyl) methacrylate, poly(propyl) methacrylate, poly(butyl) methacrylate, butylacrylate-methacrylic acid-(methyl) methacrylate copolymer, polyacrylonitrile, polystyrene, polybutadiene, polypentadiene, polyisoprene, polyisopropylene, and the like. These may be used alone or in combination. These fillers may be present in amounts of about 1% to about 80%, more preferably from about 5% to about 30% by weight of the total composition.

The thixotropic agent may include, but is not limited to, talc, fume silica, superfine surface-treated calcium carbonate, fine particle alumina, plate-like alumina; layered compounds such as montmorillonite, spicular compounds such as aluminium borate whisker, and the like. Among them, talc, fume silica and fine alumina are particularly desired. These agents may be present ion amounts of about These agents may be present in amounts of about 1% to about 50%, more preferably from 1% to about 30% by weight of the total composition.

The silane coupling agent may include, but is not limited to, γ-minopropyltriethoxysilane, γ-mercaptopropyltrimethoxysilane, γ-methacryloxypropyltrimethoxysilane, γ-glycidoxyp-ropyltrimethoxylsilane, and the like.

The curable composition according to the present invention may be obtained by mixing the aforementioned each component by means of, for example, a mixer such as a stirrer having stirring blades and a three roll mill. The composition is liquid at ambient with the viscosity of 200-400 Pa·s (at 25° C.) at 1.5s-1 shear rate, which allows its easy dispensing property.

Also provided is a method for manufacturing a liquid crystal display having a liquid crystal layer between a first substrate and a second substrate, by means of a liquid crystal one-drop-filling process. The method comprises the steps of

(a) applying the curable composition described in the present invention on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

The first substrate and the second substrate used in the present invention are usually transparent glass substrates. Generally, transparent electrodes, active matrix elements (such as TFT), alignment film(s), a color filter and the like are formed on at least one of the opposed faces of the two substrates. These constitutions may be modified according to the type of the LCD. The manufacturing method according to the present invention may be thought to be applied for any type of the LCD.

In step (a), the curable composition is applied on the periphery portion of the surface of the first substrate so as to lap around the substrate circumference in a frame shape. The portion where the curable composition is applied in a frame shape is referred as a seal region. The curable composition can be applied by a known method such as screen printing and dispensing.

In step (b), the liquid crystal is then dropped onto the center region surrounded by the seal region in the frame shape on the surface of the first substrate. This step is preferably conducted under reduced pressure.

In step (c), said second substrate is then placed over said first substrate, and UV-irradiated in the step (d). By the UV-irradiation, the curable composition cures partially and shows the strength at a level that displacement does not occur by handling, whereby the two substrates are temporally fixed. Generally, the radiation time is preferably short, for example not longer than 5 minutes, preferably not longer than 3 minutes, more preferably not longer than 1 minute.

In step (e), heating the curable composition allows it to achieve the final curing strength, whereby the two substrates are finally bonded. The thermal curing in the step (e) is generally heated at a temperature of 80 to 130° C., and preferably of 100 to 120° C., with the heating time of 30 mins to 3 hours, typically 1 hour.

By this process, the major part of the LCD panel is completed.

### Performance Data for ODF Formulations

Table I below shows inventive ODF formulations 2-4 and control formulation 1 containing commercially available Uvacure 1561, which is partially acrylated BPA diglycidyl ether. Irgacure 651 is a commercially available photoinitiator; A-187 is an adhesion promoter; EH-4357S is an epoxy hardener; SO-E2 is a silica filler. Several inventive formulations showed similar VHR moisture barrier values (Mocon) and improved corner strength as compared to the control formulation.

| | Formulations | | | |
|---|---|---|---|---|
| Materials | 1 | 2 | 3 | 4 |
| Uvacure 1561 | 66 | 60 | 60 | 60 |
| Resin 1 | | 6 | | |
| Resin 2 | | | 6 | |
| Resin 3 | | | | 6 |
| Irgacure 651 | 0.6 | 0.6 | 0.6 | 0.6 |
| A-187 | 1 | 1 | 1 | 1 |
| SO-E2 | 15.95 | 15.95 | 15.95 | 15.95 |
| EH-4357S | 16.45 | 16.45 | 16.45 | 16.45 |
| Total | 100.00 | 100.00 | 100.00 | 100.00 |
| VHR, LC25 (5 V, 6 Hz) | 95.98 | 95.11 | 95.17 | 94.65 |
| Mocon g · mil/(100 in 2 · day), | 8.29 | 9.71 | 9.46 | 9.61 |
| 50° C./100 RH | | | | |
| Corner Strength, N/mm, ITO to | 8.34 | 11.67 | 10.44 | 12.08 |
| ITO glass | | | | |
| Corner Strength after PCT(121° | 7.19 | 7.67 | 9.86 | 11.70 |
| C., 100% RH, 2 atm, 24 h), N/mm | | | | |

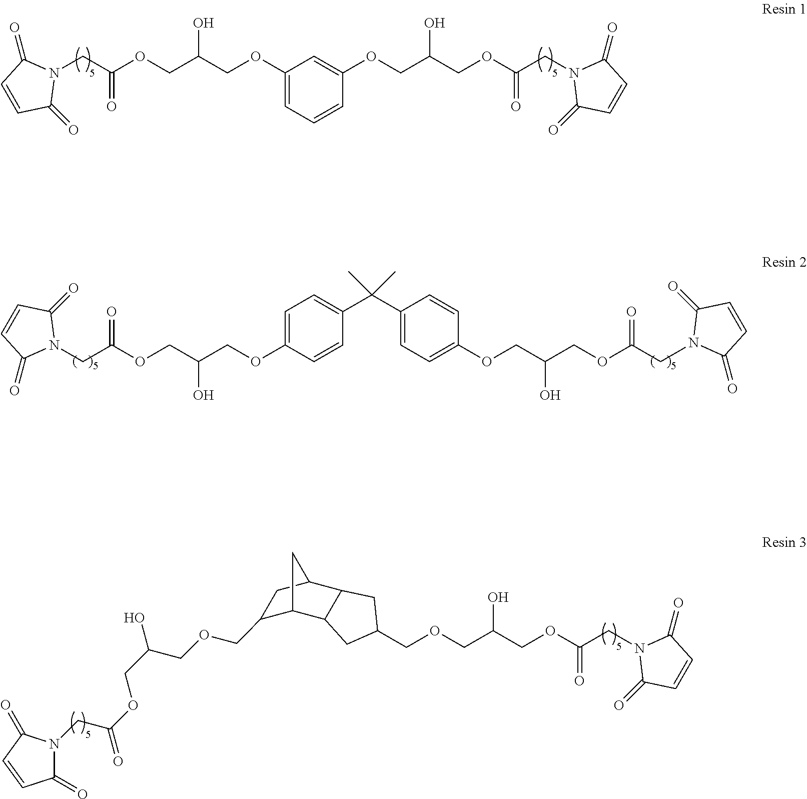

1. A resin composition comprising the structure: 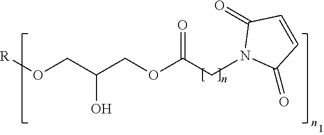
Wherein
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
n and n₁ are each independently 1-10.

2. A resin composition comprising the structure: 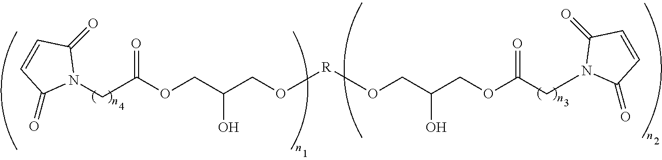
Wherein
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
n₁, n₂, n₃, and n₄ are each independently 1-10.

3. A resin composition comprising the structure: 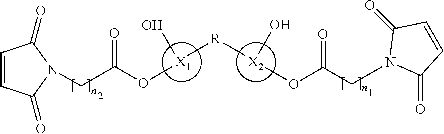
Wherein
X₁ and X₂ are 3-10 membered rings independently selected from functionalized or unfunctionalized alicyclic groups optionally having one or more heteroatoms;
n₁ and n₂ are each independently 1-10;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
R is linked to the ring structures X₁ and X₂ at any position with a proviso that the hydroxyl groups on X₁ and X₂ rings are adjacent to the maleimidoalkanoyl groups.

4. A resin composition comprising the structure: 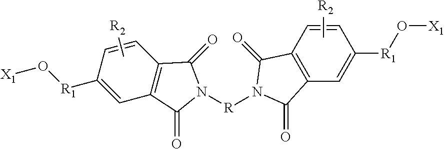
Wherein
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ is a linker group, which can be a carbonyl group; aliphatic or aromatic and may contain one or more ester, ether, hydroxyl or thioether groups;
R₂ is a substituent on the aromatic ring, which can be H, halogen, alkyl, alkyl ether, thioether group; and
X₁ is selected from maleimidoalkanoyl or maleimidoaroyl group.

5. A resin composition comprising the structure: 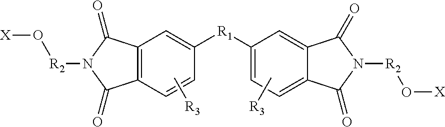
Wherein
R₁ is just a bond linking the two aromatic groups; O; carbonyl; or a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and
R₂ is an aliphatic or aromatic linker group which may contain one or more of ester, ether, hydroxyl, thioether or carbonate groups;
R₃ is a substituent on the aryl group, which may be H, halogen, alkyl, alkyl ether, or thio ether group; and
X is a polymerizable functionality selected from maleimidoalkanoyl and maleimidoaroyl groups.

6. A resin composition comprising the structure 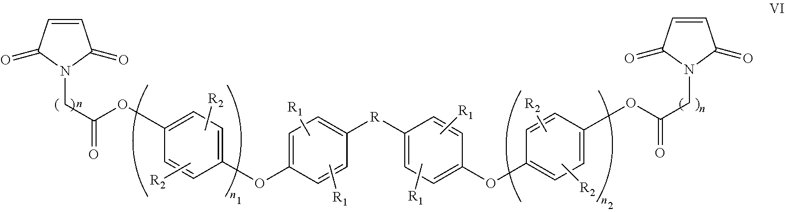
Wherein
R is a divalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ and R₂ are each linear or branched aliphatic groups optionally containing heteroatoms; and
n is 1-10, and m and n₂ are each 1-100.

7. A curable One Drop Fill (ODF) sealant composition comprising the resin structure of claim 1 and a material selected from the group consisting of free radical initiators, curing agents, fillers and combinations thereof.

8. The ODF sealant composition of claim 7 further comprising a material selected from the group consisting of photoinitiators, thixotropic agents, silane coupling agents, diluents, coloring agents, surfactants, preservatives, stabilizers, plasticizers, lubricants, defoamers, leveling agents, tougheners and combinations thereof.

9. A curable One Drop Fill (ODF) sealant composition comprising the resin structure of claim 2 and a material selected from the group consisting of free radical initiators, curing agents, fillers and combinations thereof.

10. The ODF sealant composition of claim 9 further comprising a material selected form the group consisting of photoinitiators, thixotropic agents, silane coupling agents, diluents, coloring agents, surfactants, preservatives, stabilizers, plasticizers, lubricants, defoamers, leveling agents, tougheners and combinations thereof.

11. A curable One Drop Fill (ODF) sealant composition comprising the resin structure of claim 3 and a material selected from the group consisting of free radical initiators, curing agents, fillers and combinations thereof.

12. The ODF sealant composition of claim 11 further comprising a material selected form the group consisting of photoinitiators, thixotropic agents, silane coupling agents, diluents, coloring agents, surfactants, preservatives, stabilizers, plasticizers, lubricants, defoamers, tougheners, leveling agents and combinations thereof.

13. A curable One Drop Fill (ODF) sealant composition comprising the resin structure of claim 4 and a material selected from the group consisting of free radical initiators, curing agents, fillers and combinations thereof.

14. The ODF sealant composition of claim 13 further comprising a material selected form the group consisting of photoinitiators, thixotropic agents, silane coupling agents, diluents, coloring agents, surfactants, preservatives, stabilizers, plasticizers, lubricants, defoamers, tougheners, leveling agents and combinations thereof.

15. A curable One Drop Fill (ODF) sealant composition comprising the resin structure of claim 5 and a material selected from the group consisting of free radical initiators, curing agents, fillers and combinations thereof.

16. The ODF sealant composition of claim 15 further comprising a material selected form the group consisting of photoinitiators, thixotropic agents, silane coupling agents, diluents, coloring agents, surfactants, preservatives, stabilizers, plasticizers, lubricants, defoamers, tougheners, leveling agents and combinations thereof.

17. A curable One Drop Fill (ODF) sealant composition comprising the resin structure of claim 6 and a material selected from the group consisting of free radical initiators, curing agents, fillers and combinations thereof.

18. The ODF sealant composition of claim 17 further comprising a material selected form the group consisting of photoinitiators, thixotropic agents, silane coupling agents, diluents, coloring agents, surfactants, preservatives, stabilizers, plasticizers, lubricants, defoamers, tougheners, leveling agents and combinations thereof.

19. A method for manufacturing a liquid crystal display having a liquid crystal layer between a first substrate and a second substrate, comprising:
(a) applying the curable composition of claim 1 on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

20. A method for manufacturing a liquid crystal display having a liquid crystal layer between a first substrate and a second substrate, comprising:
(a) applying the curable composition of claim 2 on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

21. A method for manufacturing a liquid crystal display having a liquid crystal layer between a first substrate and a second substrate, comprising:
(a) applying the curable composition of claim 3 on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

22. A method for manufacturing a liquid crystal display having a liquid crystal layer between a first substrate and a second substrate, comprising:
(a) applying the curable composition of claim 4 on a sealing region at periphery of a surface of the first substrate;
(b) dropping liquid crystal on a central area encircled by the sealing region of the surface of the first substrate;
(c) overlaying the second substrate on the first substrate;
(d) Optionally performing partial curing by UV-irradiating the curable composition, and
(e) performing final curing by heating the curable composition.

23. A method for manufacturing a liquid crystal display having a liquid crystal layer between a first substrate and a second substrate, comprising:
(a) applying the curable composition of claim 5 on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

24. A method for manufacturing a liquid crystal display having a liquid crystal layer between a first substrate and a second substrate, comprising:
(a) applying the curable composition of claim 6 on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition
